(19) United States
(12) Patent Application Publication
(10) Pub. No.: US 2005/0004954 A1
(43) Pub. Date: Jan. 6, 2005

(54) Systems and methods for expedited data transfer in a communication system using hash segmentation

(75) Inventor: Robert Marion Soule III, Harrisburg, NC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Hand Held Products, Inc., Charlotte, NC (US)

(21) Appl. No.: 10/611,015

(22) Filed: Jul. 1, 2003

(51) Int. Cl. G06F 17/30

(52) U.S. Cl. 707/203

(57) ABSTRACT

The present invention provides for an improved method and system for determining differences in data sets or data files, expedited data transfer and data reconciliation in a communication network using hash segmentation processing. The system and method provides for an efficient means of communicating updated files, new revisions or verifying files between a source host and a target host. By implementing hash segmentation processing, and in many embodiments iterative hash segmentation processing, the updates within the files can be isolated for the purpose of minimizing the amount of data communicated from the source host to the target host. The system and methods provide for the transfer of data between two hosts in instances in which neither host is aware of the revision that exists on the other host. The hash segmentation process may implement a logarithmic hash approach or a sliding linear hash approach.

### FIELD OF THE INVENTION

The present invention relates to electronic data transfer, and more particularly to systems and methods for determining variances in datasets and expediting the transfer of data in communication networks by implementing hash segmentation routines.

### BACKGROUND OF THE INVENTION

In computer networking and, in particular, in wireless computer networking, the ability to transfer data efficiently is a paramount concern. Recent developments in computing have made it possible for increasingly larger and larger files; such as executable files, text files, multimedia files, database files and the like, to be stored within a single memory device; making it possible for increasingly smaller portable computing devices to store and implement these large files. In the networking environment these files are transferred from a source host to one or more target hosts via communication medium, such as cable, broadband, wireless and the like.

It is the nature of computer software, data files, data sets and the like that it is often desirable to update or revise the software, data files or data sets in order to add features, update data, correct errors or recognize changes. Sometimes these revisions are extensive and require the entire updated data file or data set to be transferred from the source host to the target hosts. However, in many instances the changes are relatively minor, involving changes in only a small percentage of the data that makes up the file.

In instances where only minor changes to the file have occurred it is inefficient, costly and time-consuming to be burdened with transferring the entire updated file to the target host. If an entire new revised file must be delivered, the amount of data can be substantial. It is not unusual in today's computer network environment for files upwards of 10 Megabytes or larger to exist and require frequent updating. Distribution of such large files across wired or wireless medium can take an undesirably long period of time and can consume a large amount of server resources.

For example, a hand held computing device, such as a personal data assistant, an imager scanner or other portable computing devices are now equipped to implement conventional operating system, like Windows™ (Microsoft Corporation; Redmond, Wash.), that include large datasets. It is often desirable for the administrator of a fleet of these devices or for the device manufacturer to update the data files or data sets residing on the devices. In certain instances, this will require the administrator or manufacturer to send out files or data set updates to every device that exists in the field and it may require the administrator or manufacturer to assess what revisions or what changes have been implemented by the user of a field deployed device.

If the entire file or dataset is updated typically a compression algorithm is employed. These programs typically achieve compression of a large executable file down to between 40 percent to 60 percent of its original size and can compress some types of files even further. However, for very large computer files or collections of files, even a compressed file reduced to 40% still represents a substantial transmission cost in terms of transfer time and server occupancy.

For portable devices that typically rely on a battery power supply, transferring entire files or datasets consumes large amounts of power. As such, the transferring of entire files or datasets in the portable device realm is often restricted by power limitations or requires that the device be connected to a DC power source for the transfer operation.

In instances in which the entire updated file is not transferred, differencing programs or comparator programs have been used to compare an old file to a new revised file in order to determine how the files differ. The differencing or comparator program generates a patch file, and then using that patch file in combination with the old file to generate a newly revised file. While these types of “patching” systems do not transfer the entire updated file they do require that both versions (i.e., the old revision and the new revision) exist on one host for the purpose of comparing, line by line the two versions to determine the “patch”. Additionally, most commonly available versions of these systems are limited to text file comparisons and updating.

More recently hashing algorithms or hashing functions have been used to promote the transfer of data and to implement updated revisions to files. Hashing is the transformation of a string of characters into a usually shorter fixed-length value or key that represents the original string. Traditionally, hashing has been used to index and retrieve items in a database because it is faster to find the item using the shorter hashed key than to find it using the original value. The hash function is used to index the original value or key and then used later each time the data associated with the value or key is to be retrieved. A good hash function also should not produce the same hash value from two different inputs. If it does, this is known as a collision. A hash function that offers an extremely low risk of collision may be considered acceptable.

For example, U.S. Pat. No. 6,263,348, issued to Kathrow et al., Jul. 17, 2001, teaches a method for hashing some or all of the files to be compared and allowing comparison of the hash results to identify whether differences exist between the files. Files that have a different result may be identified as having differences, and files that hash to the same number may be identified as unlikely to have differences. The Kathrow '348 patent teachings are a bi-level approach for partial hashing of files and a comparison of the hash results to isolate differences. Since the process taught in Kathrow '348 is limited to files existing on a single host and a single memory module, the patent does not concern itself with a means of isolating the differences in the files to insure that the amount of data actually transmitted between two hosts is minimized to insure maximum transfer efficiency is realized. Additionally, the patent provides no teaching as to how realignment of segment boundaries may occur after an insertion or deletion has been detected in the file. The concept of realignment provides reconciliation in those applications in which the source host is unaware of the exact data that exists on the target host.

Similar to the Kathrow teachings, U.S. Pat. No. RE 35,861, issued to Queen et al., on Jul. 28, 1998, addresses a method for comparing two versions of a text document by partial hashing of the files and comparison for the purpose of isolating differences. The method taught in the Queen '861 patent is similar to patching, in that it requires both versions of the text document to reside on one host for the purpose of comparison. In addition, the Queen teaching is limited to text files and does not teach an iterative process that isolates the differences to insure the minimal amount of data is transferred between hosts.

By way of another example, U.S. Pat. No. 6,151,709, issued to Pedrizetti et al., on Nov. 21, 2000, teaches a method for comparing software on a client computer against a set of updates on a server computer to determine which updates are applicable and should be transferred to the client. A hash function is applied to update identifiers to generate a table of single bit entries indicating the presence of particular updates on the server. At the client level the same hashing function is applied to program identifiers and corresponding entries of the transferred tables are checked to determine whether the server has a potential update. Thus, the hashing routine is not implemented to determine differences in the file, but rather it is implemented to determine the file identifiers to determine or update the bit filed index.

Therefore, the need exists to develop a method and system for determining differences in datasets and expediting the transfer of data effectively and efficiently between data files existing on separate hosts. In most instances, efficient transfer should significantly reduce the time required to transfer updates and limit the number of transferring resources required of the transferring host. An effective system and method should provide for the transfer of data between source host and target host in instances in which neither host is aware of the revision that exists on the other host. The method and system should effectively isolate the data that has been revised, updated, added or deleted in order to limit the data that is transferred from the source host to the target host.

### SUMMARY OF THE INVENTION

The present invention provides for an improved method and system for determining variances in datasets, expediting data transfer and data reconciliation in a communication network using hash segmentation approaches. The systems and methods provide for an efficient means of communicating updated files, new revisions or verifying files between a two distinct hosts. By implementing a hash segmentation approach, and in many embodiments an iterative hash segmentation approach, the updates within the files can be isolated for the purpose of minimizing the amount of data communicated from one host to the other host.

In one embodiment of the invention a method for determining the variances in datasets residing on separate hosts in a communication network is defined by the steps of creating first hash values, at a first host, corresponding to a plurality of segments of a first dataset and creating second hash values, at a second host, corresponding to a plurality of segments of a second dataset. Once the hash values have been created a comparison ensues whereby one or more first hash values is compared to the second hash values to determine which segments of the datasets differ. Typically, the hash value comparison will occur at either the first or second host after the first hash values have been communicated from the first host to the second host or after the second hash values have been communicated from the second host to the first host. In an alternate embodiment, the first and second hash values may be communicated to a third host with comparison of the first and second hash values occurring at the third host.

In a specific embodiment of the invention, if the comparison of the hash values determines that one or more segments of the first dataset differ from the second dataset then the host at which the first dataset resides will communicate the one or segments to the second host. The second host will typically compile a third dataset, referred to herein as a target dataset, that comprises those segments determined to differ, which have been communicated from the first host, and those segments determined not to differ, which are transferred from the second dataset residing on the second host. Alternatively, the third dataset may be compiled at the first host or at a third host.

The communication of differing segments from the first host to the second host may occur automatically upon determination of a differing segment or communication may occur after a predetermined threshold of differences has been attained. Additionally, the process may entail the step of determining whether or not the differences should be communicated from one host to another. This determination may be based on the size of the difference (i.e., some differences may be so large as to be impractical to transmit on an available medium of communication) or the determination may be made based on the resources required to communicate the differing segments. In this regard, battery power consumption may prohibit communication of the differing segments of the dataset if the hosts are communicating in a wireless network. Thus, the decision may be made to postpone the communication of the differences while the hosts are in wireless communication until the hosts are in wired communication, via cable, broadband, DSL, modem or the like.

Another novel feature of the present invention is the ability of the method to isolate the differences between the first and second dataset. By isolating the difference(s) the amount of actual data communicated between the hosts can be minimized. For example, once a determination is made that a segment differs between the source dataset and the suspect dataset and the length of the segment exceeds a predetermined length, further isolation will be necessary to identify where in the segment the difference occurs. Isolation of the differences within the segments of the datasets occurs by iteratively creating subsequent hash values for sub-segments of the segments determined to differ. In one embodiment this will require creation of third hash values, at the first host, corresponding to sub-segments of a segment of the first dataset determined to have differed and creation of fourth hash values, at the second host, corresponding to a sub-segments of the corresponding segment of the second dataset determined to have differed. Once the third and fourth hash values have been created a comparison of the values occurs to determine which sub-segment(s) of the segment differ. Iterative isolation may require subsequent hash value creation and comparison to isolate the difference to an acceptable level as dictated by a static or dynamically determined difference threshold. Once differing sub-segments have been isolated to the degree necessary communication of the sub-segments may be required between the hosts and compilation of a third dataset may be required.

In another embodiment of the invention a method for determining differences between datasets residing on separate hosts in a communication network includes the steps of creating first dataset hash values, at a first host, corresponding to segments of a first dataset and searching, at a second host, for segments of a second dataset that have matching hash values to the first dataset hash values using a slide function of a sliding hash algorithm. This method will typically involve creating, at a second host, a first hash value for a first segment of a second dataset and comparing the first hash value of the first segment of the second dataset to the first dataset hash values to determine if the first hash value matches any of the first dataset hash values. If the comparison determines that no match exists for the hash value of the first segment of the second dataset then a slide function is performed. The slide function allows the first segment to move a predetermined length to create a hash value of the second segment. Once hash value is created for the second segment, the second hash value is compared to the first dataset hash values to determine if the second hash value matches any of the first dataset hash values.

In the sliding hash algorithm approach, the segment of the second dataset is iteratively slid, either backward or forward by a predetermined length to define new hash values for segments of the second dataset. In this regard, the slide operation entails realigning the suspect dataset segment by a predetermined length, typically a minimum length, such as 1 byte. Once the slide function occurs, a hash value for the new realigned segment is created and this hash value is compared to all of the entries in the source dataset hash list to determine if a match exists. If a determination is made that the hash value for a segment of the second dataset and a segment of the first dataset are equal then the segment of the second dataset is copied to a third dataset. Upon completion of the iterative slide function segmentation and hash processing, if a determination is a made that no match exists within the first dataset hash list, the first host may communicate all of the unmatched segments from the first dataset to the second host for inclusion in the third dataset.

In accordance with yet another embodiment of the invention, a system for expedited data transfer and data reconciliation is provided. The system comprises a first processor residing in a first host, the first processor implements a hash algorithm to create first hash values corresponding to segments of a first dataset. In addition, the system includes a second processor residing in a second host and in network communication with the first processor, the second processor implements the first hash algorithm to create second hash values corresponding to segments of a second dataset. The second processor compares the first hash values to the second hash values to determine which segments of the datasets differ. The hash algorithm may be a logarithmic hash algorithm, a sliding linear hash algorithm or the like. If the comparison determines that one or more of the first dataset segments differ from the second dataset then the first processor communicates to the second processor the differing segments.

The system may additionally include a compiler, residing in the second host, which compiles a third dataset that includes those segments of the first dataset determined to differ from the second dataset and those segments of the second dataset determined not to differ from the first dataset. In addition the system may include the following features, the second processor may be capable of searching in the second dataset for a match to a subset of one of the first dataset segments communicated from the first host, both processors may work in unison to iteratively determine where, within the segments that have been determined to differ, the differences occur. Determining where the differences occur will typically involve the first and second processors isolating, iteratively, one or more differences within the one or more segments of the first and second datasets determined to have differed.

Therefore, the present invention provides for an improved method and system for expedited data transfer and data reconciliation. The method and systems of the present invention can effectively and efficiently perform data transfer and data reconciliation between data files existing on separate hosts. The resulting efficient transfer of data significantly reduces the time required to transfer updates and limits the number of transferring resources required to perform the transfer operation. The method and system is capable of effectively isolating the data that has been revised, updated, added or deleted in order to limit the data that is transferred from the source host to the target host. In addition the system provides for data reconciliation in those applications in which the neither host is aware of the exact data that exists on the other host.

### BRIEF DESCRIPTION OF THE DRAWINGS

FIG. 1 illustrates a block diagram of a system for expedited data transfer and data reconciliation, in accordance with an embodiment of the present invention.

FIG. 2 is a flow diagram of a method for determining differences in datasets, in accordance with an embodiment of the present invention.

FIG. 3 is a flow diagram depicting the composite flow of data transfer and data reconciliation process implementing a logarithmic hash segmentation process, in accordance with an embodiment of the present invention.

FIG. 4 is block diagram depicting the creation of a logarithmic hash list, in accordance with an embodiment of the present invention.

FIG. 5 is a flow diagram depicting the process for comparing two hash lists to determine matched hash list entries, in accordance with an embodiment of the present invention.

FIG. 6 is a flow diagram illustrating a the procedure for copying matched segments of the suspect dataset to the target dataset and copying unmatched segments of the source dataset to the target dataset, in accordance with an embodiment of the present invention.

FIG. 7 is a flow diagram depicting the process for realigning the hash list of a suspect dataset after a difference has been isolated to a predetermined or dynamically determined segment length, in accordance with an embodiment of the present invention.

FIG. 8 is a flow diagram depicting the composite flow of the expedited data transfer and data reconciliation process implementing a sliding hash segmentation method, in accordance with an embodiment of the present invention.

FIG. 9 is a block diagram illustrating the creation of a linear hash list, in accordance with an embodiment of the present invention.

FIG. 10 is a flow diagram illustrating the process for performing a sliding comparison of hash values, in accordance with an embodiment of the present invention.

FIG. 11 is an example of a dataset in which a sliding hash algorithm is applied, in accordance with an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention provides for improved methods and systems for determining dataset variance and expediting data transfer in a communication network using hash segmentation processing. The systems and methods provide for an efficient means of communicating updated files, new revisions or verifying files between a source host and a target host. By implementing hash segmentation processing, and in many embodiments iterative hash segmentation processing, the updates within the files can be isolated for the purpose of minimizing the amount of data communicated from the source host to the target host. The hash segmentation process may implement a logarithmic hash segmentation approach, a sliding hash segmentation approach or another suitable hashing approach.

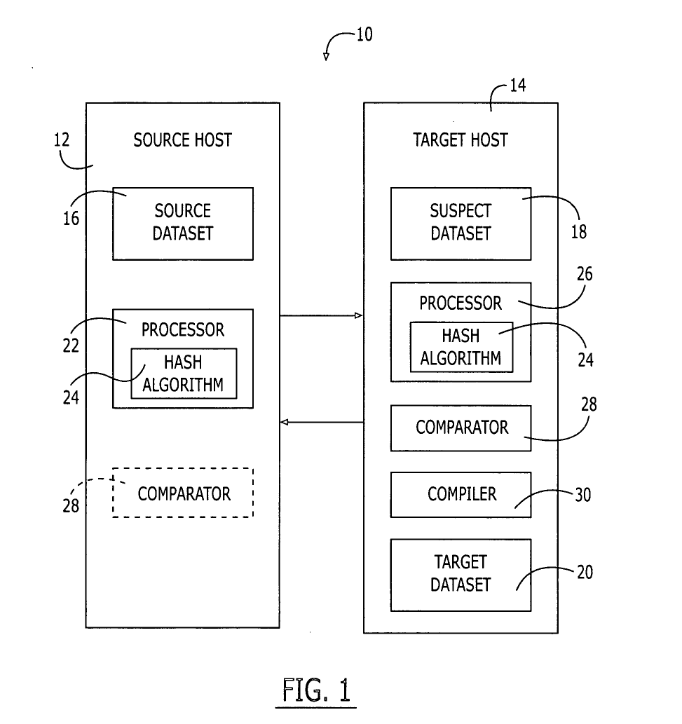

FIG. 1 depicts a block diagram of a system for expedited data transfer and data reconciliation in accordance with an embodiment of the present invention. The system 10 comprises a source host 12 that is in network communication with one or more target hosts 14. The network communication link may be via wired media, such as broadband, cable, ISDN or the like or the communication link may be via wireless media. The source host may be one of a plurality of source hosts, such as servers or the like, that communicate via a network with remote client or target hosts. For example, the source host may be one of a series of servers operated by a portable communication device administrator or manufacturer, such as a PDA administrator, a portable imager/scanning device administrator or other portable computer device administrator or manufacturer. The source host communicates with the client or target hosts (i.e., the field deployed communication devices) as a means of providing the target hosts with updates to applications, revisions to files, corrections to file errors and the like. It should be noted that the detailed description refers to the hosts as source hosts and target hosts for the sake of clarity. The hosts may also be referred to generically as first and second hosts.

The source host 12 either stores or has access to a first dataset, i.e. the source dataset 16, which may be an updated or revised version of the required dataset. The target host stores or has access to a second dataset, i.e., the suspect dataset 18, which may be an outdated or un-revised dataset, a corrupt dataset, an amended dataset, a completely unrelated dataset or the like. The system of the present invention serves to detect the differences in the second dataset compared to the first dataset and, in most embodiments, compile a target dataset 20 either at the target host or in communication with the target host.

The differences between the source dataset and the suspect dataset are determined by implementing a hashing mechanism that segments the datasets and applies hash values to the segments for subsequent comparison. The source host 12 includes a first processor 22 that implements a hash algorithm 24 to create a hash list corresponding to the segments of the source dataset. The hash algorithm may be a conventional hash algorithm, such as the conventional MD5 algorithm; a sliding hash algorithm, such as the sliding algorithm herein disclosed or the hash algorithm may be any other appropriate hash algorithm. The target host 14 includes a second processor 26 that is in network communication with the first processor such that hash lists and segments of datasets can be communicated between the processors. The second processor implements the same hash algorithm 24 as the source host to create hash values corresponding to segments of the suspect dataset.

A comparator 28 is implemented at the target host to determine if hash values for corresponding segments are equal; signifying that the segments match, or unequal; signifying that the segments do not match. If further segmentation of the unmatched segment is warranted to isolate the differences, further hash segmentation is performed on the segment of the source and target datasets at the respective source and target hosts. This isolation process may continue, iteratively, until the difference is isolated to the degree necessary. This iterative processing may require the comparator 28 to be implemented on the source host, as well as, the target host.

A compiler 30 is implemented at the target host and serves to compile the target dataset from those segments of the suspect dataset determined to match the source dataset and those segments communicated from the source dataset that were determined not to match the corresponding segment of the suspect dataset.

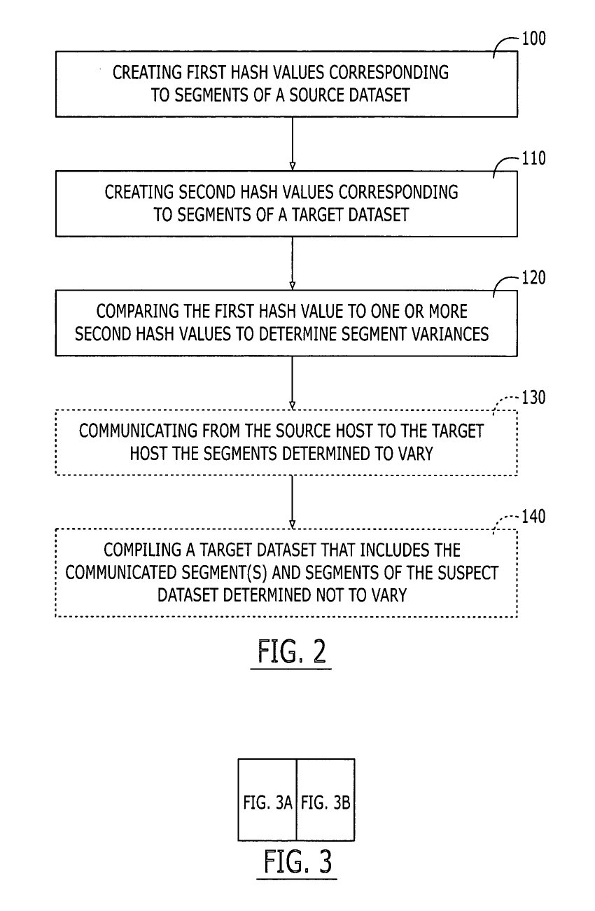

The present invention is also embodied in a method for determining differences in datasets and optionally expediting data transfer and data reconciliation. FIG. 2 is flow diagram detailing the generic flow for a method for determining differences in datasets, in accordance with an embodiment of the present invention. At step 100, first hash values are created corresponding to segments of a source dataset residing on a source host and, at step 110, second hash values are created corresponding to segments of a suspect dataset residing on a target host. At step 120, the first hash values are compared to one or more second hash values to determine segment variances.

Once a determination is made that one or more segments vary, the source host may, optionally at step 130, communicate to the target host the segments determined to vary. The communication of varying segments from the source host to the target host may occur automatically upon determination of a varying segment or communication may occur after a predetermined threshold of differences has been attained. Additionally, the process may entail an optional step (not shown in FIG. 2), which determines whether or not the differences should be communicated from one host to another. This determination may be based on the size of the difference (i.e., some differences may be so large as to be impractical to transmit on an available medium of communication) or the determination may be made based on the resources required to communicate the differing segments. The process may also entail an optional step of choosing, from various communication mediums, a communication medium by which to transmit the differing segments based on the total length of the differing segments. In this regard, battery power consumption may prohibit communication of the differing segments of the dataset if the hosts are communicating in a wireless network. Thus, the decision may be made to postpone the communication of the differences while the hosts are in wireless communication until the hosts are in wired communication, via cable, broadband, DSL, modem or the like.

At optional step 140, the target host compiles a target dataset that includes the communicated segments from the source host and those segments of the suspect dataset that were determined not to differ from the corresponding source dataset segment.

The method may also be defined by searching within the suspect dataset for a match to a subset of the one or more segments that have been communicated from the source host. This search process provides realignment of data segment boundaries after an insertion or deletion has been detected by the hashing routine. This provides reconciliation in those applications in which the source host is unaware of the exact data that exists in the corresponding file on the target host.

The method may also be defined by isolating, iteratively, one or more variances within the one or more segments of the source and suspect datasets determined to have varied. Iterative isolation of the variances may involve further hash segmentation of the segments that have been determined to vary. For example, once a determination is made that a source dataset segment and a suspect dataset segment varies and the length of the segment exceeds a predetermined or dynamically determined threshold further isolation will be necessary to identify where in the segment the variance occurs. This process will be accomplished by creating, at the source host, a third list of hash values corresponding to sub-segments of the source dataset segment determined to have differed and creating, at the suspect host, a fourth hash value list corresponding to sub-segments of the suspect dataset segments determined to have differed. Once the third and fourth hash segmentation lists have been created the hash lists are compared to determine which sub-segments of the datasets differ. This process may continue iteratively until the differing segment is identified, in length, to the degree necessary.

The invention is also embodied in methods for data transfer and data reconciliation that implement hash segmentation algorithms. Two such embodiments are detailed below and implement, respectively, a logarithmic hash segmentation approach and a sliding hash segmentation approach. The general notion of a sliding hash algorithm is novel and within the bounds of the inventive concepts herein disclosed.

Logarithmic Hash Segmentation Method and System

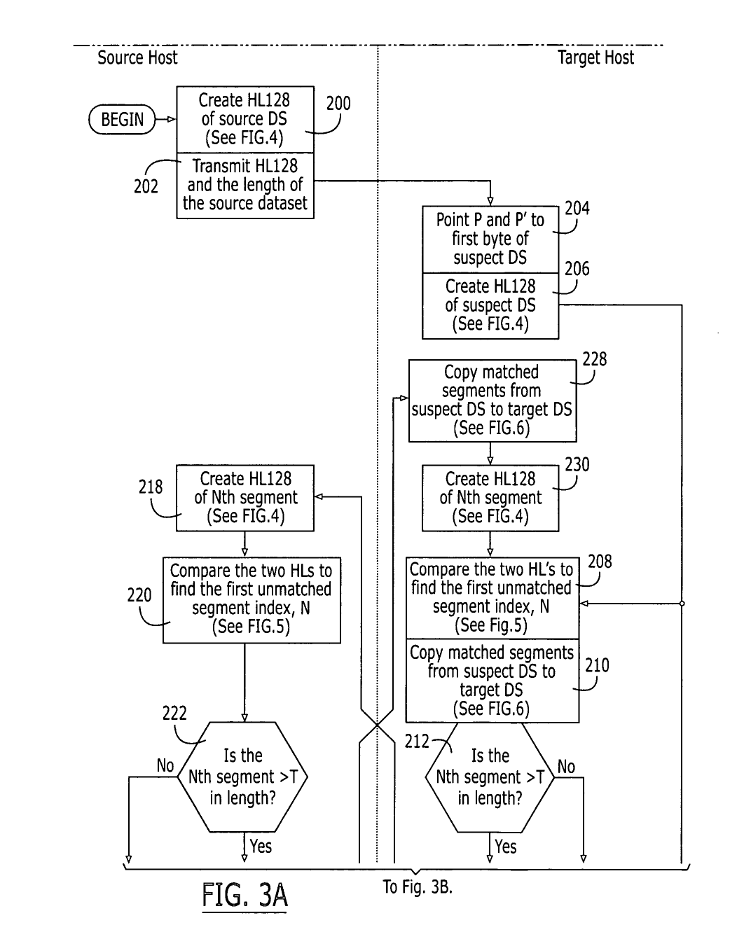

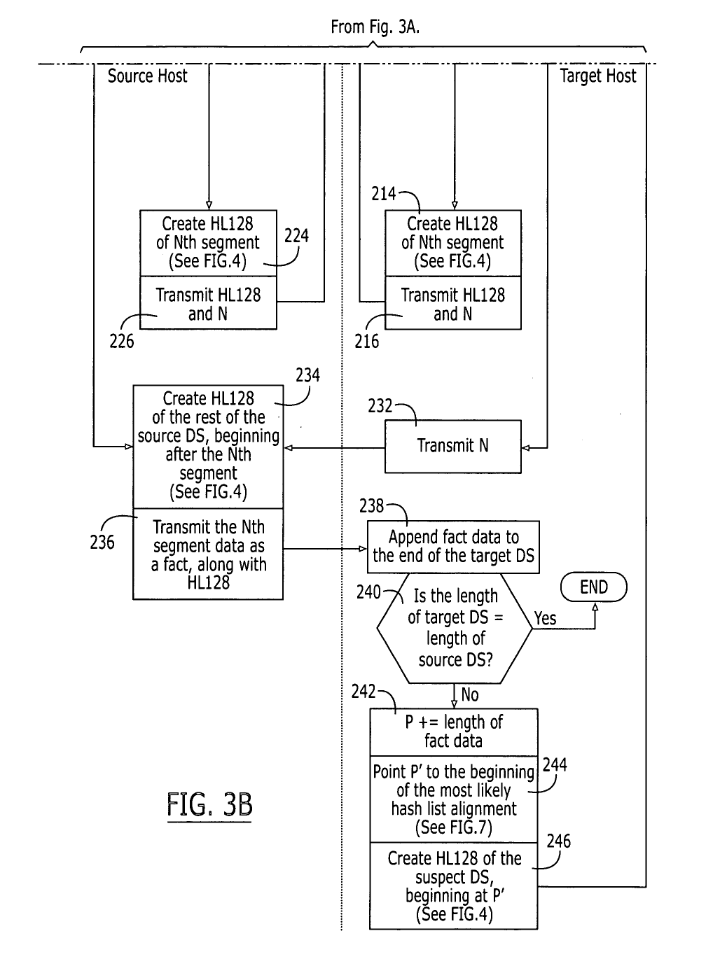

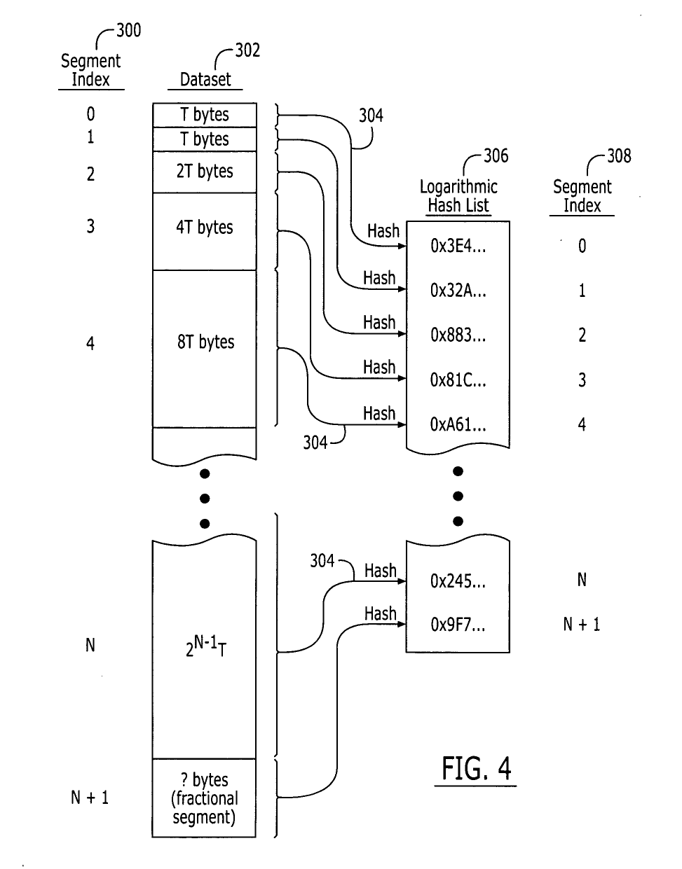

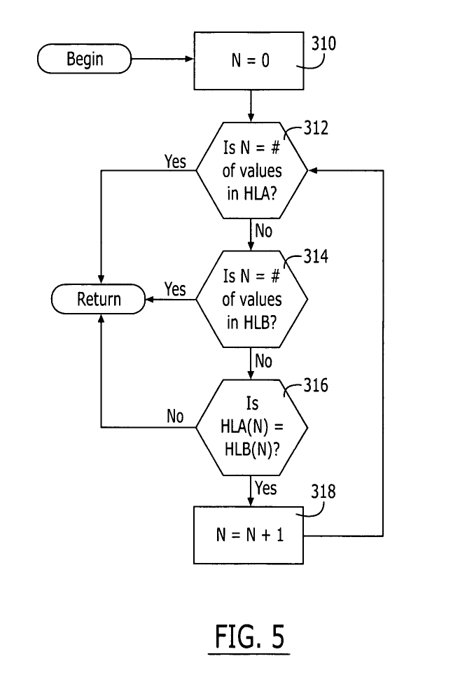

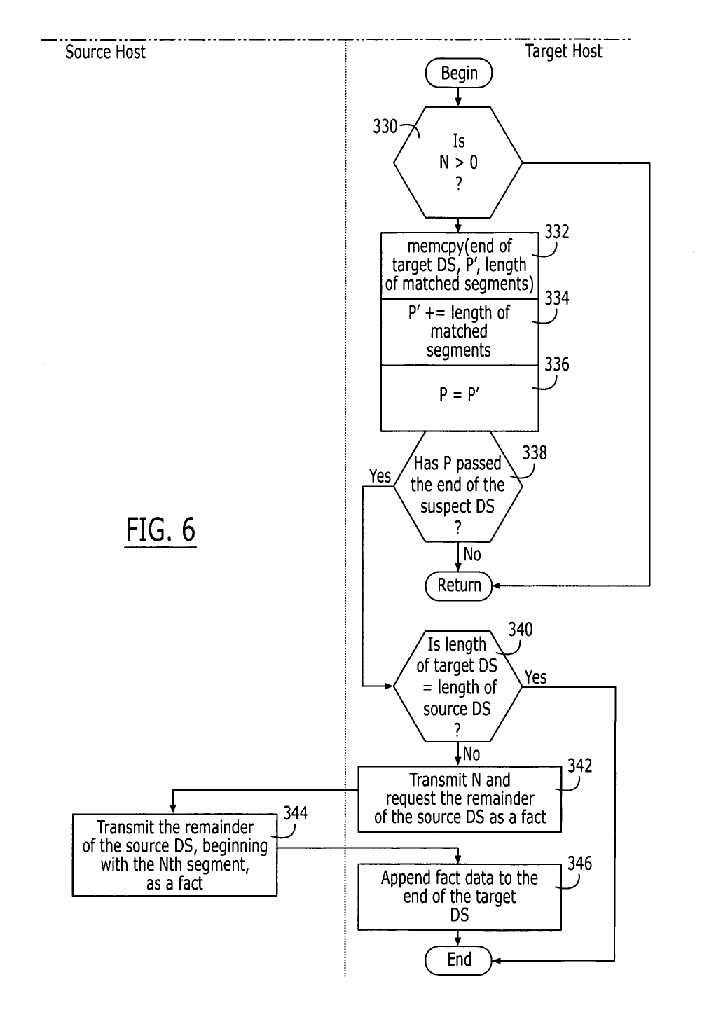

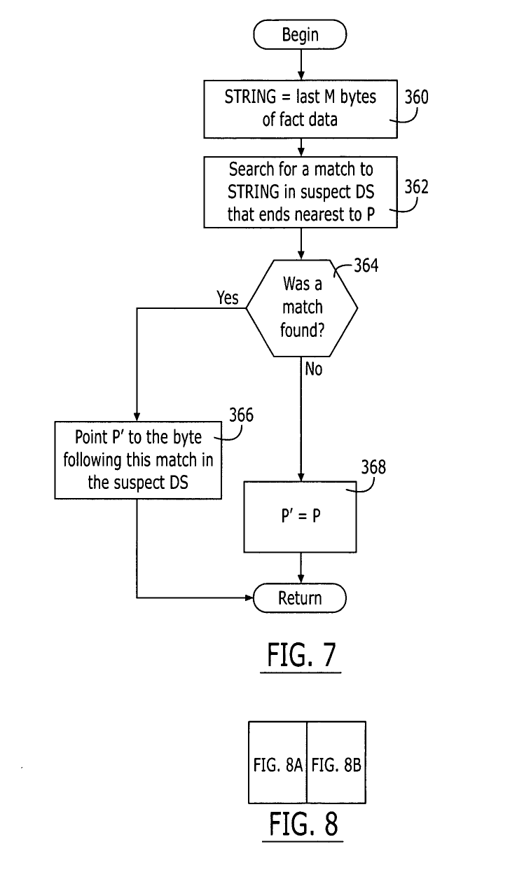

FIGS. 3-7 provide a detailed flow of the method and system for expedited data transfer and data reconciliation using a logarithmic hash segmentation approach, in accordance with an embodiment of the present invention. FIG. 3 is a flow diagram of the composite method and system for expedited data transfer and data reconciliation using logarithmic hash segmentation. FIGS. 4-7 are block and flow diagrams for sub-routines within the composite method detailed in FIG. 3. Specifically, FIG. 4 details a block diagram for creating logarithmic hash lists, FIG. 5 details the flow for comparing two hash lists, FIG. 6 details the flow for duplicating matched segments of data and FIG. 7 details the flow for realigning a hash list to the suspect dataset. It should be noted that while steps of the process are shown to occur sequentially it is also possible and, within the inventive concepts herein disclosed, to perform steps in parallel on the source host and the target host as a means of expediting the overall process.

Referring to FIG. 3, the flow diagram, which details the composite method and system for expedited data transfer and data reconciliation using logarithmic hash segmentation, is described in detail herein. It is noted that the broken line that generally runs down the center of the flow diagram distinguishes between those processes of the method that are undertaken at the source host and those steps that are undertaken at the target host. The host at which a process occurs in implementing the present invention may, in practice, differ from the host designated in the FIG. 3 embodiment. In certain embodiments it is possible that the processes of the method herein disclosed may occur in a host other than the source host or the target host. Therefore, the embodiment shown in FIG. 3 should not be construed as limiting the present invention in terms of which host performs a specified process or task.

For the sake of complete understanding we define the source host and the target host as follows. The source host is defined as the host at which the source dataset resides or the host which has access to the source dataset. The source dataset is the dataset that requires comparison to other datasets and, which may require some level of transfer to the target host. The target host is defined as the host at which the suspect dataset resides or the host which has access to the suspect dataset. The target host is also the host at which the target dataset is built. The suspect dataset may differ from the source dataset and, if a determination is made that a difference exists, data is transferred from the source dataset to a newly formed dataset, referred to herein as the target dataset.

The data transfer and data reconciliation process begins, at step 200, by creating at the source host a logarithmic hash list of the entire source dataset. By way of example, the hash list may be created by implementing a strong 128-bit hash algorithm, such as the MD5 hash algorithm. The MD5 hash algorithm is well known by those of ordinary skill in the art and creates an entry in the hash list for every 128 bits of data. FIG. 4 provides a more detailed block diagram depiction of the creation of logarithmic hash lists.

Referring to FIG. 4, shown is a block diagram of the creation of a logarithmic hash list, in accordance with an embodiment of the present invention. The dataset that requires hashing is first logically subdivided into one or more segments. These segments are numerically listed in the segment index column, 300 beginning with segment 0 and ending with segment N+1. The first segment of the dataset is given a parameter, T, bytes in length or the length of the dataset, whichever is less. Each subsequent segment is of length, (2^{N-1}T), where N is defined as the 0-based segment index, shown in column 300, or the length of the remaining dataset, whichever is less. Thus, depending on the value assigned to T and the length of the dataset being hashed, the final segment may not be an exact multiple of T in length, unlike the remaining segments. Column 302 shows the segmented dataset in terms of the length as defined by the logarithmic equation (2^{N-1}T).

Once the dataset is segmented, the logarithmic hash list is created by performing a hash algorithm on each of the segments, denoted by the arrows 304. As noted above, one example of such a hash algorithm is the MD5 algorithm. After the hash algorithm is performed each resulting hash value is placed in the Nth position in the hash list, which is the 0-based segment index. An example of the logarithmic hash list is illustrated in column 306 and the segment index is repeated in column 308. Thus, as shown, a one-to-one correlation exists between each segment of the dataset and a corresponding hash list entry. The length of the hash list entry is a function of the hash algorithm that is used.

Those skilled in the art will recognize that reconfiguring the logic or adding additional logic to detect “early out” conditions can enhance the methods described herein. “Early out” conditions refer to conditions in which an algorithm can detect that the goal or task has already been completed, typically earlier than presumed. One such example of an “early out” in the present application is the creation of a 128-bit hash value comparison between the entire source dataset and the entire suspect dataset prior to commencing comparison of individual hash values. If the 128-bit hash value comparison results in the values being equal, the two files or datasets are determined to be equivalent and the process can end prematurely.

Referring again to FIG. 3, the data transfer process continues, at step 202, by transmitting the hash list and the overall length of the source dataset from the source host to the target host. The communication or transmission of data may occur over wired or wireless communication media. Once the target host receives the hash list from the source host, at step 204, two pointers, identified herein as P and P′, are set to the first byte of the suspect dataset. This step initializes P and P′ as variables. The variable P is used to mark the progress of analysis through the suspect dataset. The variable P′ is used to mark the estimated point in the suspect dataset where the hash list aligns to the suspect dataset. Further details regarding the use of the P and P′ variables will be discussed at length below in relation to the realignment of the hash list to the suspect dataset as detailed in the flow of FIG. 7. Once the pointers are set, at step 206, a hash list is created of the suspect dataset. The hash list will be created using the same segmentation process and hash algorithm that was implemented on the source dataset.

Once the suspect dataset hash list has been created a comparison is performed, at step 208, that compares the source dataset hash list to the suspect dataset hash list to determine the first unequal hash list entry. Unequal hash list entries indicate that there is a difference between the source dataset and the suspect dataset within the corresponding segment. FIG. 5 provides a more detailed flow of the process involved in comparing two hash lists.

Referring to FIG. 5, at step 310, the comparison process begins by setting the zero-based index of the hash list entry that will be compared. In the initial iteration of the process and for any subsequent comparisons of hash lists, the first hash list entry in each list is compared, thus, N is set to zero. At steps 312 and 314 a determination is made as to whether N is equal to the number of values in the source dataset hash list and the suspect dataset hash list, respectively. These routines insure that the process has not encountered the end of either hash list. If a determination is made that N is equal to the number of values in either hash list, the comparison routine returns to the composite flow of FIG. 3, at step 210, if the comparison processing is occurring at the target host, or at step 222, if the comparison processing is occurring at the source host. If a determination is made that N does not equal the number of values in either of the hash lists then, at step 316, a comparison is made to determine if the Nth value in the source and suspect hash lists are equal. If comparison determines that the hash values are not equal then the comparison routine has determined that a difference exists for this particular segment and the comparison routine returns to the composite flow of FIG. 3, at step 210, if the comparison processing is occurring at the target host, or at step 222, if the comparison processing is occurring at the target host. If the comparison determines that the hash values are equal then, at step 318, the next hash entry in the each list is considered by incrementing the segment index by one and returning the flow to step 312. This process continues until a hash value difference is determined or all hash values have been compared and no further differences between hash values have been determined.

Referring again to FIG. 3, once the comparison of the two hash lists is performed and the first unmatched segment index, N has been determined, at step 210, the matched segments (i.e., the segments preceding N in the hash lists that were determined to be equal) are copied from the suspect dataset to target dataset. Since both the suspect dataset and the target dataset will typically reside on the target host, there will be no need to transmit data at this stage in the process. FIG. 6 provides a more detailed flow of the process involved in copying matched segments.

Referring to FIG. 6, at step 330, the copying process begins by determining if index value, N, is greater than zero. If N is greater than zero then matched segments must have been determined during the hash list comparison routine. If N is equal to zero then matched segments have not been determined and the process returns to the composite flow shown in FIG. 3, at the next step. If N is determined to be greater than zero then, at step 332, the matched segments are copied from the suspect dataset to the target dataset. The matched datasets will include those segments with indices less than N. At step 334, the pointer, P′ is incremented by the length of the matched segments and, at step 336, pointer, P is defined as being equal to pointer, P′ because at least one segment was matched and therefore the hash list alignment estimate is considered valid.

At step 338, a query is performed to determine if there are remaining segments of the suspect dataset still requiring processing. This query is accomplished by determining if the pointer, P has passed the end of the suspect dataset. If pointer, P has not passed the end of the suspect dataset, then more segments of the suspect dataset remain to be processed, at which point, the flow returns to the composite data transfer flow of FIG. 3, at the next step. If pointer, P has passed the end of the suspect dataset, then no more segments of the suspect dataset remain to be processed and, at step 340, a determination is made as to whether the length of the target dataset is equal to the length of the source dataset. If it is determined that the lengths of the datasets are equal then the data transfer or reconciliation process has already been completed and the overall data transfer and reconciliation process ends. If the lengths of the target and source datasets are not equal then, at step 342, then the value of N is transmitted to the source host along with a request for transmission of the remainder of the source dataset.

After the source host has received the value of N and the request for data transfer, at step 344, the source host transmits the remainder of the source dataset beginning with the Nth segment. At step 346, the target host receives the remainder of the source dataset and appends the remainder of the source dataset to the end of the target dataset. Once the remainder of the source dataset is appended to the target dataset the data transfer and reconciliation process is complete.

Returning to the composite data transfer and data reconciliation flow of FIG. 3, at step 212, a determination is made as to whether the Nth segment of the suspect dataset, the segment in which a difference has been determined, is greater than T in length. T, defines the threshold length at which further iterative isolation of the difference occurs. In practice, it is often convenient to set, T, to the length of the first dataset segment. It is possible for multiple threshold lengths and corresponding variables, T, to exist with individual threshold lengths applying to different iterations of the isolation process.

Thus, if the Nth segment of the suspect dataset is greater than T in length then further isolation of the difference is warranted and, at step 214, the target host creates a hash list of the Nth segment. The creation of the Nth segment hash list will typically implement the same hash algorithm that was implemented for the creation of the overall source dataset and the overall suspect dataset. This will typically mean that the Nth segment hash list will be created by implementing a strong 128 bit hash algorithm, such as MD5 or the like. In this instance, the creation of the Nth segment hash list will be accomplished by the same flow that is illustrated in FIG. 4 and discussed at length above. It is also possible and within the inventive concepts herein disclosed to implement a different hash algorithm or a different segmentation scheme for the iterative isolation of differences, as long as, the same algorithm and/or segmentation scheme is used on the source host and the target host for the specified iterative pass.

After the hash list of the Nth segment of the suspect dataset has been created, at step 216, the target host transmits to the source host the Nth segment value and the hash list of the Nth segment of the suspect dataset. Upon receipt of the Nth segment value and the hash list of the Nth segment of the suspect dataset the source host, at step 218, creates a hash list of the Nth segment of the source dataset using the same hash algorithm that has been used previously. At step 220, a comparison of the two Nth segment hash lists is undertaken to find the first unmatched segment index, N. (It is noted that the previous unmatched segment index, N is dropped and the Nth segment is modified so that it currently refers to segment index, N.) The comparison of the two Nth segment hash lists will be accomplished by the same flow that is illustrated in FIG. 5 and discussed at length above.

After the comparison is accomplished an Nth segment is identified and, at step 222, a determination is made as whether the length of the Nth segment is greater than the length of T. This determination is made to determine if further isolation within the Nth segment is necessary to further isolate the difference prior to communicating the segment from the source host to the target host. If the determination is made that the length of the Nth segment is greater than the length of T then, at step 224, the source host creates a hash list of the Nth segment of the source dataset using the previously implemented hash algorithm. Once the hash list of the Nth segment of the source dataset has been created, at step 226, the Nth index value and the hash list of the Nth segment of the source dataset are transmitted to the target host. Once the Nth index value and hash list of the Nth segment of the source dataset are received by the target host, steps 228, 230 and 208 ensue, whereby matched Nth segments from the suspect dataset are copied to the target dataset, a hash list of the Nth segment of the suspect dataset is created and a comparison of the two Nth segment hash lists is performed to find the first unmatched segment index N. These processes are implemented in accordance with the flows illustrated in FIGS. 6, 4 and 5, respectively and discussed at length above. This process iterates back and forth between the source host and the target host until the difference between the source dataset and the suspect dataset has been isolated to a suitably small segment. A suitably small segment is defined as a segment equal to or less than T in length.

At steps 212 and 222 if a determination is made that the Nth segment is equal to or less than the length of T then the iterative process of further isolation of the difference is ended. If the determination is made at the target host then, at step 232, the Nth index is transmitted from the target host to the source host. Upon receipt by the source host of the Nth index, the source host, at step 234, creates a hash list of the remainder of the source dataset beginning after the Nth segment using the same hash algorithm that has been used previously. The creation of the hash list of the remainder of the source dataset will be implemented using the same flow illustrated in FIG. 4 and discussed at length above. If the determination that the length of the Nth segment is equal to or less than T is made at the source host, there is no need to transmit the Nth index to the source host and, as such, step 234 ensues.

At step 236, the source host transmits the hash list of the remainder of the source dataset along with the source dataset Nth segment. Once the target dataset receives the hash list and the source dataset Nth segment, at step 238, the source dataset Nth segment is appended to the end of the target dataset. At step 240, a determination is made as to whether the transfer of data is complete. This determination is accomplished by determining if the length of the target dataset is equal to the length of the source dataset. If the lengths are equal then the transfer is complete and the process ends. If the lengths are not equal then further data reconciliation and subsequent data transfer are necessary.

Once a determination is made that the lengths are not equal and, therefore, further data reconciliation is warranted, at step 242, the pointer, P is incremented by the fact data length and, at step 244, the pointer, P′ is set in the suspect dataset to the beginning of the most likely hash list alignment. Pointer, P′ is set in an attempt to realign the hash list comparison, i.e., recover from an insertion or a deletion in the suspect dataset. FIG. 7 provides a more detailed flow of the process involved in realigning the hash list to the suspect dataset.

Referring to FIG. 7, at step 360, we define “STRING” as the last M bytes of data that was appended to the target dataset. M is a predefined or dynamically determined segment length that is typically significantly smaller in length than the set value for T. At step, 362, a search is conducted within the suspect dataset for a match to “STRING”. The search begins at the pointer, P, which was previously incremented by the fact data length (step 242 of FIG. 3). Beginning at the pointer, P the search continues both forward and backward within the suspect dataset in order to compensate for possible insertions or deletions that have occurred within the suspect dataset. A determination is made, at step 364, whether a match has been found within the suspect dataset for “STRING”. If a match is found then it is likely that the source dataset hash list, which the source host just transmitted to the target host (step 236 of FIG. 3), will best align to the suspect dataset just after the matched segment. Therefore, at step 366, the pointer, P′ is set to the first byte in the suspect dataset that follows the match and the routine returns to the composite data transfer and data reconciliation flow shown in FIG. 3, at step 246. If a match is not found within the suspect dataset then, at step 368, pointer, P′ is set to pointer, P because no better alignment estimate can be determined beyond P and the flow returns to the composite data transfer flow shown in FIG. 3, at step 246. It is also possible, and within the inventive concepts of the invention, to restrict the realignment search to a specified range beginning at pointer, P.

Returning again to the composite flow of FIG. 3, at step 246, the target host creates a hash list of the suspect dataset beginning at pointer, P′. The hash list will be created using the same segmentation process and hash algorithm previously implemented and illustrated in the flow depicted in FIG. 4 and discussed at length above. Once the hash list of the suspect dataset has been created the flow returns to step 208 for a comparison of the hash list of the remainder of the source dataset and the just created hash list of the suspect dataset. The comparison is undertaken to determine the first unmatched segment index of the hash lists, in accordance with the flow illustrated in FIG. 5 and described at length above. Once the first unmatched segment index has been identified, at step 210, the segments that preceded the unmatched segment are copied from the suspect dataset to the target dataset, according to the flow illustrated in FIG. 6 and described at length above.

This flow continues until the entire suspect dataset has been compared to the source dataset via the creation and comparison of hash lists. Once comparisons of the hash lists are made determinations are made to assess whether further isolation of the difference is necessary to insure minimal data transfer between the source host and the target host. If further isolation is warranted an iterative hashing process ensues to isolate the discrepancy. Once all segments have been compared and differences have been isolated, a target dataset will have been assembled that consists of segments of the source dataset that were determined to be different from the suspect dataset and segments of the suspect dataset that were determined not to be different from the source dataset.

Linear Hash Segmentation Method and System

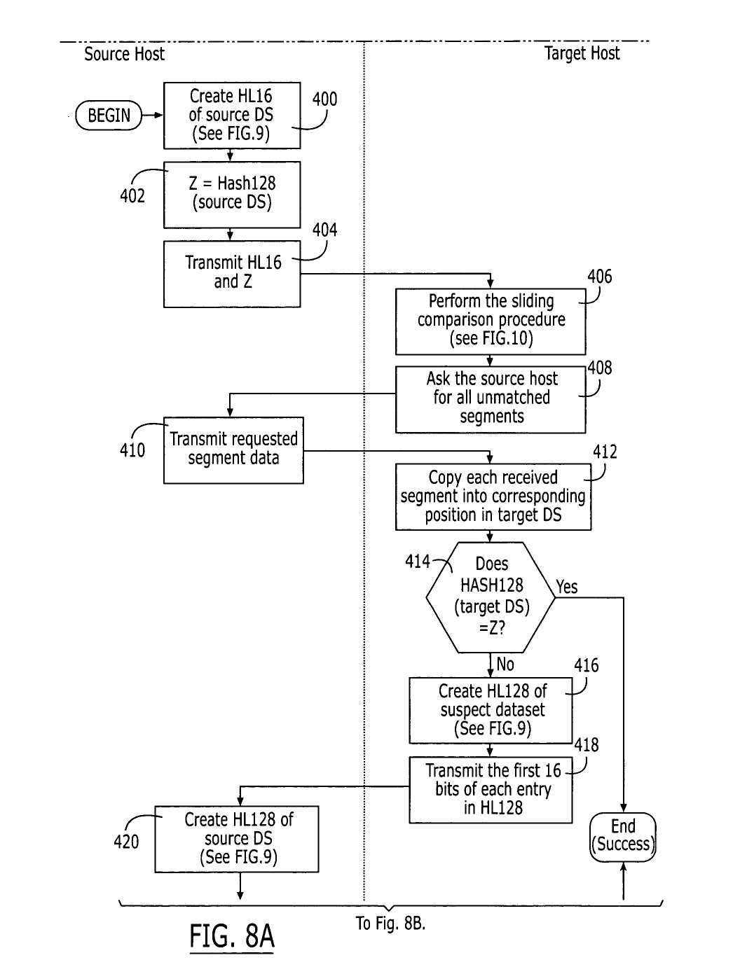

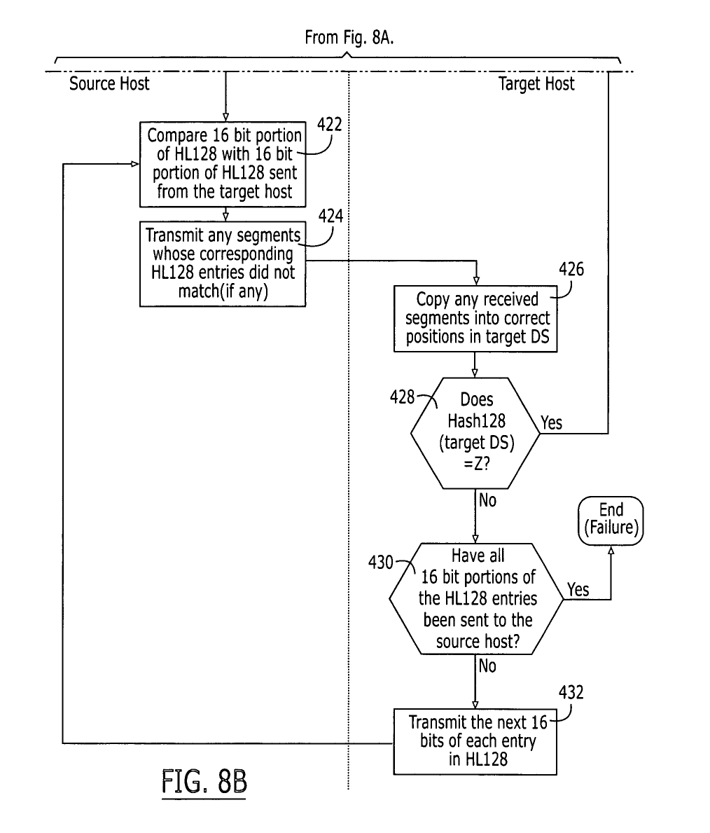

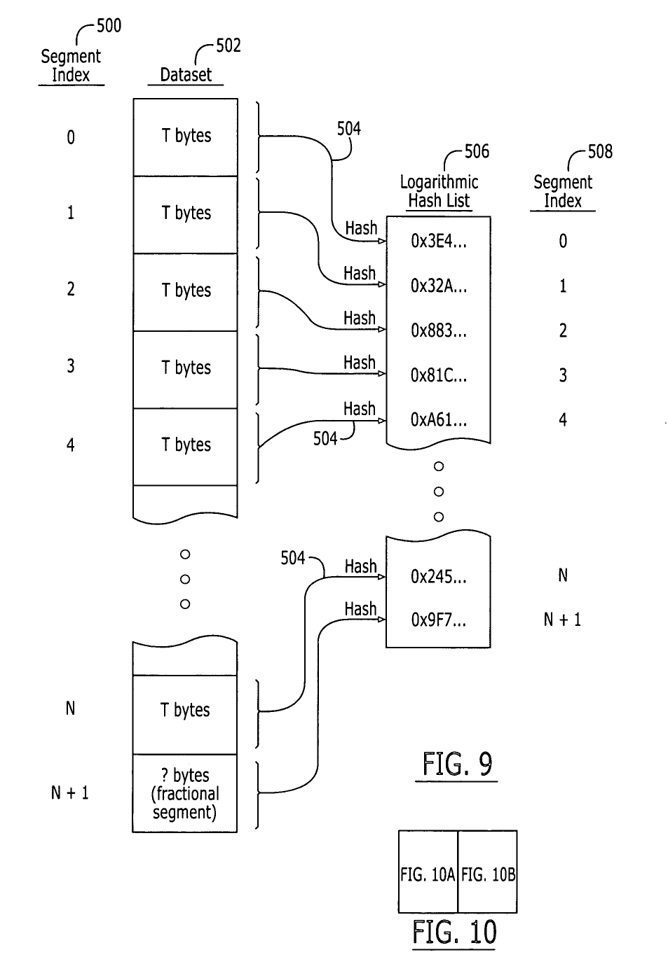

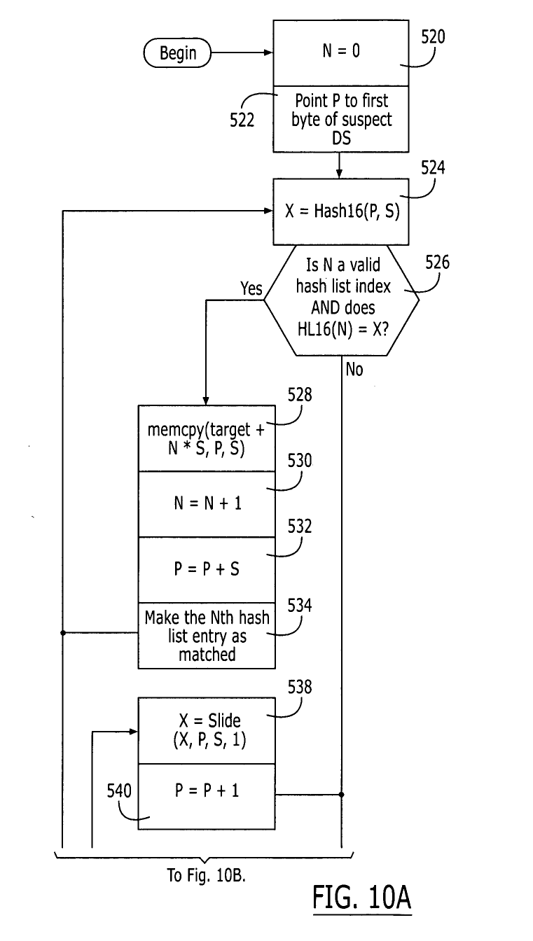

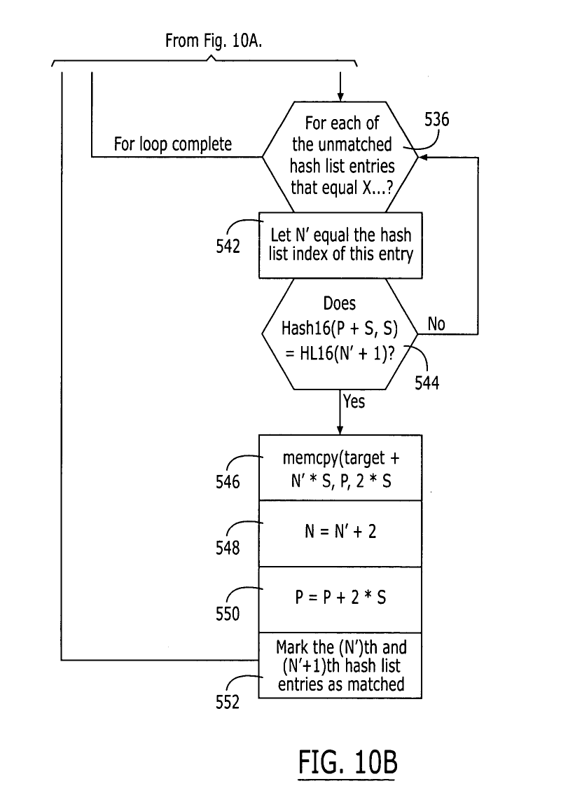

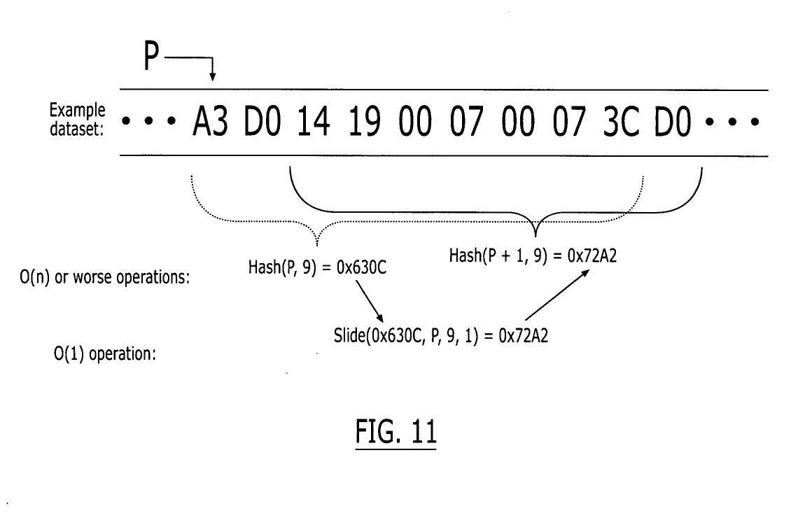

FIGS. 8-11 provide a detailed flow of the method and system for expedited data transfer and data reconciliation using a sliding linear hash segmentation approach, in accordance with an embodiment of the present invention. FIG. 8 is a flow diagram of the composite method and system for expedited data transfer and data reconciliation using sliding linear hash segmentation. FIGS. 9-10 are flow and block diagrams for sub-routines within the composite method detailed in FIG. 8. Specifically, FIG. 9 is a block diagram depicting the creation of linear hash lists, FIG. 10 details a sliding comparison process and FIG. 11 details example results of a sliding hash algorithm. It should be noted that while steps of the process are shown to occur sequentially it is also possible and, within the inventive concepts herein disclosed, to perform steps in parallel on the source host and the target host as a means of expediting the overall process.

Referring to FIG. 8, the flow diagram, which details the composite method and system for expedited data transfer and data reconciliation using linear hash segmentation, is described in detail herein. It is noted that the broken line that generally runs down the center of the flow diagram distinguishes between those processes of the method that are undertaken at the source host and those steps that are undertaken at the target host. The host at which a process occurs in implementing the present invention may, in practice, differ from the host designated in the FIG. 8 embodiment. In certain embodiments it is possible that the processes of the method herein disclosed may occur in a host other than the source host or the target host. Therefore, the embodiment shown in FIG. 8 should not be construed as limiting the present invention in terms of which host performs a specified process or task.

The data transfer and data reconciliation process begins, at step 400, by creating at the source host a linear hash list of the entire source dataset. By way of example, the hash list may be created by implementing a 16-bit sliding hash algorithm, which will be described in detail below. The 16-bit sliding hash algorithm is a generally weaker algorithm than the 128-bit hash algorithm but is sufficiently strong for the data reconciliation purpose and provides efficiency for the overall data transfer process. FIG. 9 provides a more detailed flow of the creation of linear hash lists.

Referring to FIG. 9, shown is the flow of the creation of a linear hash list, in accordance with an embodiment of the present invention. The dataset that requires hashing is first logically subdivided into one or more segments. These segments are numerically listed in the segment index column, 500, beginning with segment 0 and ending with segment N+1. The first segment and each subsequent segment of the dataset is given a parameter, T, bytes in length or the length of the dataset, whichever is less. Thus, depending on the value assigned to T and the length of the dataset being hashed, the final segment may not be exactly T in length, unlike the remaining segments. Column 502 shows the segmented dataset in terms of the length, each segment being T bytes in length.

Once the dataset is segmented, the linear hash list is created by performing a hash algorithm on each of the segments, denoted by the arrows 504. As noted above, one example of such a linear hash algorithm is the sliding hash algorithm described below. After the hash algorithm is performed each resulting hash value is placed in the Nth position in the hash list, where N is the 0-based segment index. An example of the linear hash list is illustrated in column 506 and the segment index is repeated in column 508. Thus, as shown, a one-to-one correlation exists between each segment of the dataset and a corresponding hash list entry. The length of the hash list entry is a function of the hash algorithm that is used.

Referring again to FIG. 8, once the source dataset hash list is created, at step 402, the source host creates a single hash value, Z, for the entire source dataset. The single hash value, Z, is generated using a strong 128-bit hash algorithm, such as MD5 or the like. The single hash value is created to ensure successful transfer of the source data from the source host to the target dataset residing at the target host. At step 404, the source host transmits the linear hash list and the single hash value, Z, to the target host. Once the target host receives the linear hash list and the single hash value, at step 406, the target host performs a sliding comparison procedure to attempt to locate segments in the suspect dataset that have hash values that match entries in the source dataset hash list. FIG. 10 provides a more detailed flow of the process for performing the sliding comparison procedure

Referring to FIG. 10, at step 520, the comparison is initiated by considering the first segment of the source dataset, N=0 and, at step 522, considering the first segment of the suspect dataset by pointing the marker, P, to the first byte of the suspect dataset. At step 524, a 16-bit hash value, X is created for the first segment of the suspect dataset. For example, if the length of a segment of the source dataset is 256 bytes, the length of the first segment of the suspect dataset will also be 256 bytes. At step 526, a determination is made as to whether N is a valid hash list index and whether the hash value, X is equal to the corresponding hash value in the source dataset hash list. The validation of N is undertaken to determine if the entire hash list has been processed through the segment match process. If N is determined to be valid and X is equal to the corresponding hash value in the source dataset then, at step 528, the Nth hash list entry of the source hash list is marked as being matched and, at step 530 the corresponding segment of the suspect dataset is copied to the target dataset. Once the copy process has been completed, at step 532, N is set to N+1 and, at step 534, P is set to P+S (where S is the length of a segment of the source dataset, in bytes) for the purpose of comparing the next segment of the source dataset to the next segment of the suspect dataset. At this point the process returns to step 524, where a hash value, X is created for the next segment of the suspect dataset.

If, at step 526, either N is determined to be an invalid hash list index (i.e., the end of the source hash list has been encountered) or the hash value, X, of the suspect dataset segment does not equal the corresponding hash value in the source hash list then, at step 536, a determination is made as to whether X equals any value in the source hash list. In typical embodiments of the invention it will beneficial to sort the hash list prior to performing the step 536 determination so that a binary search of the hash list can be performed to identify matches for, X. If X does not equal any other segment then the slide aspect of the 16-bit sliding hash algorithm is implemented. At step 538, the hash value, X undergoes a “slide” function, whereby the alignment of the suspect segment is moved one byte to the right. At step 540, P is updated to reflect the new segment alignment of the suspect dataset that is being considered for matching.

In accordance with an embodiment of the present invention, a sliding hash algorithm is defined. By way of example, the sliding hash algorithm may be implemented in a simple 16-bit checksum or in a stronger 16-bit shifting XOR that begins with a non-zero seed value.

In the simple 16-bit checksum example the hash value is computed by creating a 16-bit summation of the value of all bytes in the range of interest and discarding any overflow. Implementing the 16-bit checksum algorithm on a subset of a dataset, the subset being N bytes in length, the algorithm will have O(N) performance. By way of example, the source code for such a hash algorithm may be defined as follows:

WORD Hash(Byte *P, int N)
{

WORD X = 0;
for (; N > 0; N--)

X += *P++;

return X;

}

Once the hash of the subset has been calculated one time in this manner, the hash can be “slid” to either the left or the right with O(1) performance. In other words, the previously calculated hash value can be used to determine the new hash value much more expeditiously than calling Hash(P+1, N). For this example, the following function may be used to “slide” the previously calculated hash value to the right by a single byte:

WORD SlideRight(WORD X, BYTE *P, int N)
{

return X − P[0] + P[N];

}

For the 16-bit checksum hash algorithm, the slide function subtracts the first byte of the previously hashed segment and then adds the final byte of the new segment that is under consideration.

The 16-bit checksum algorithm described above is considered a weak hash algorithm, in that; it commonly produces the same hash value for different inputs. This phenomenon is referred to in the art of computer programming as a hash collision. To lessen the likelihood of collisions occurring, a stronger hash algorithm may be implemented. For example, a 16-bit shifting XOR algorithm that begins with a non-zero seed value, such as 0×1357 will provide for stronger protection against hash collisions. For each byte of input data, the current value is rotated to the left one bit (the highest order bit is rotated to the lowest order position and all other bits are shifted to the left one position) and the input byte is bitwise XORed to this value, for example:

#define ROTL(x, n) (((x) <<((n) & 0xF)) | ((x) >> (0x10 − ((n) & 0xF))))
WORD Hash(BYTE *P, int N)
{

WORD X = 0x1357;
for (; N > 0; N--)

X = ROTL(X, 1) [symbol] *P++;

return X;

}

The 16-bit shifting XOR hash algorithm can be slid to the right one byte with O(1) performance using the following function:

WORD SlideRight(WORD X, BYTE *P, int N)

{

return ROTL(X, 1) [symbol] ROTL(0x1357, N + 1)

[symbol]

ROTL(0x1357 [symbol] P[0], N) [symbol] P[N];

}

Similar to the 16-bit checksum example, the 16-bit shifting XOR slide function removes the effects of the first byte of the previously hashed segment and adds the effects of the final byte of the new segment under consideration. However, for the 16-bit shifting XOR algorithm it is also necessary to take into account the amount that the first byte, the final byte and the seed value have been shifted into the result. The 16-bit shifting XOR algorithm is used to generate the example values shown in FIG. 11, where the function, SlideRight (X,P,N), stated above is equivalent to the more general function, Slide (X,P,N,1) in FIG. 11.

FIG. 11 illustrates an example of a portion of a suspect dataset and the implementation of the sliding aspect of the sliding hash algorithm, in accordance with an embodiment of the present invention. The marker, P is set to the beginning of the segment that will be hashed. S defines the number of bytes in the segment; in this example each segment comprises 9 bytes. As such, the hash value of the first segment, Hash (P, 9)=0×630C. Within the sliding hash algorithm an O(C)-performing function, Slide (X, P, S, C) exists such that Slide (Hash (P, S), P, S, C)=Hash (P+C, S) for all valid inputs. As such, the sliding hash algorithm allows for any calculated hash value of a segment of a dataset to have a hash value of the same-sized segment that starts C bytes later in the dataset to be calculated in time proportional to C (constant time for C=+1 or C=−1). This aspect of the sliding hash algorithm provides for significant timesavings over having to perform the hash algorithm on each byte of the second segment. Additionally, this hash algorithm allows for a search to be performed efficiently through a large dataset for a segment of known size that has a known hash value. To perform this slide function, the hash algorithm need only be applied once, to the Hash (P, S) segment in order to find the hash value of that particular segment. All other segment hash values are efficiently calculated by “sliding” the first hash value through the dataset using the slide function. Thus, for the example dataset shown in FIG. 11, if the slide function, Slide (X, P, S, C) is applied to the segment Hash (P, 9)=0×630C the result is Slide (0×630C, P, 9, 1) or Hash (P+1, 9)=0×72A2.

Referring again to FIG. 10, once the slide function has been performed and P has been appropriately updated the flow returns to step 536 where a determination is performed to assess whether any of the source dataset hash list entries match the hash value, X. If no matches exist, the flow returns to step 538, where the slide function moves the segment by one byte to redefine the value of X. If, however, a determination is made that the sliding hash value has a matched value in the source dataset hash list then a validation of this match must occur. This validation process is necessary due to the likelihood of collisions occurring within the relatively weak sliding hash algorithm. To increase the probability of a valid match, each potential match is examined to determine if the subsequent segment of the suspect dataset also matches its corresponding position in the hash list. Thus, once the sliding aspect of the algorithm ensues, byte-by-byte, for a match to be confirmed, at least two adjacent S-sized suspect dataset segments must have the same sliding hash values as two adjacent S-sized source dataset segments.

The validation process discussed above ensues, at step 542, where N′ is assigned to the hash list index of the hash list entry that matches the hash value of the suspect dataset. At step 544, a determination is made as to whether the hash value of the next S-sized suspect dataset segment, Hash 16(P+S, S) is equal to the hash value of the next S-sized source dataset segment, HL16 (N′+1). If a determination is made that the next segments do not have equivalent hash values then the routine returns to step 536, for a determination of the next match between the source dataset hash list entries and the hash value of the suspect dataset, X. If no further matches are determined the flow returns to steps 538 and 540 for further slide function processing or if matching is determined the flow returns to steps 542 and 544 for further validation of the match via next segment matching.

If a determination is made that the next segments of the suspect and source datasets do have equivalent hash values the, at step 546, the matching segments, i.e., the two consecutive segments, are copied from the suspect dataset to the target dataset. At steps 548 and 550 the next segment is considered for match by setting the N index in the source dataset hash list to N′+2 and setting the pointer in the suspect dataset to P+(2*S). At step 552, the N′th and the (N′+1)th hash list entries are marked as being matched and the flow returns to step 524, where a new hash value is determined for Hash16 (P, S).

It should be noted that for the sliding comparison flow illustrated in FIG. 10, the routine will return to the composite flow of FIG. 8, at step 408, when the pointer, P has moved through the entire suspect dataset. Thus, it is possible for the flow to return to the composite after steps 522, 532, 540 or 550 if pointer, P+S is determined to have passed the end of the suspect dataset.

Referring again to FIG. 8, at step 408 the target host transmits a query to the source host asking for all unmatched data segments to be sent from the source dataset. At step 410, after the source host has received the request the source host transmits the requested unmatched segments of the source dataset to the target host. At step 412, after the target host has received the unmatched segments, the segments are copied into their corresponding positions in the target dataset. In order to validate the transfer of the unmatched source datasets and their positioning in the target dataset, at step 414, a 128-bit hash value of entire target dataset is created and it is compared with Z hash value of the entire source dataset. If it is determined that the hash values of the entire source and target datasets are equivalent then the transfer and reconciliation are deemed to have been successful and the process is completed. If, however, it is determined that the hash value of the entire target dataset and, Z, the hash value of the entire source dataset are not equal then, at step 416, a 128-bit hash value is created for each segment of the target dataset that is marked as matched and these values are concatenated into a linear hash list, HL128.

At step, 418, the first 16-bit portion of each entry in the HL128 hash list is transmitted from the target host to the source host. Once the source host receives the HL128 hash list, at step 420, the source hosts calculates a 128-bit hash value for each segment of the source dataset that has not been requested by the target host. These hash values are then concatenated into a linear hash list, HL128. At step 422, the source host compares the first 16-bit portion of each entry in the source dataset HL128 with the first 16-bit portion of the target dataset HL128 to determine if matches exist. Any source dataset segments whose corresponding HL128 entry did not match are transmitted, at step 424, from the source host to the target host.

Once the target host receives the source dataset segments, at step 426, the segments are copied into their respective positions within the target dataset. At step 428, a 128-bit hash value is created for the entire target dataset and this hash value is compared to the hash value for the entire source dataset, Z. If it is determined that the hash values of the entire source and target datasets are equivalent then the transfer and reconciliation are deemed to have been successful and the process is completed. If, however, it is determined that the hash value of the entire target dataset and, Z, the hash value of the entire source dataset are not equal then, at step 430, a determination is made as to whether all 16-bit portions of the target dataset hash list have been transmitted to the source host. If it is determined that all 16-bit portions of the target dataset hash list have been sent and the dataset hash values are not equal, the transfer and reconciliation process is ended unsuccessfully. If it is determined that not all of the 16-bit portions of the target dataset hash list have been sent then, at step 432, the target host transmits to the source host the next 16 bits of each entry in the target dataset HL128 hash list.

Once the source host receives the next 16 bits of each entry in the target dataset HL128, at step 422, the source host compares the next 16 bits of each entry in the target dataset HL128 with the next 16 bits in the source dataset HL128 to determine if matches exist. Any source dataset segments whose corresponding HL128 entry did not match are transmitted, at step 424, from the source host to the target host. This process continues until the hash values of the entire source dataset and target dataset are equal representing successful transfer and reconciliation or until all of the 16 bit portions of the target dataset HL 128 have been transmitted and the hash values of the entire source and target datasets have been determined to not be equal, thus, signifying an unsuccessful transfer and reconciliation process.

Therefore, the present invention provides for an improved method and system for expedited data transfer and data reconciliation. The method and systems of the present invention can effectively and efficiently perform data transfer and data reconciliation between data files existing on separate hosts. The resulting efficient transfer of data significantly reduces the time required to transfer updates and limits the number of transferring resources required to perform the transfer operation. The method and system is capable of effectively isolating the data that has been revised, updated, added or deleted in order to limit the data that is transferred from the source host to the secondary host. In addition the system provides for data reconciliation in those applications in which the neither host is aware of the revision that exists on the other host.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limiting the scope of the present invention in any way.

1. A method for determining differences between datasets residing on separate hosts in a communication network, the method comprising the steps of:
creating first hash values, at a first host, corresponding to a plurality of segments of a first dataset;
creating second hash values, at a second host, corresponding to a plurality of segments of a second dataset; and
comparing one or more first hash values to the second hash values to determine which segments of the datasets differ.

2. The method of claim 1 further comprising the step of communicating the first hash values from the first host to the second host and wherein the step of comparing one or more first hash values to the second hash values to determine which segments of the datasets differ further comprises comparing, at the second host, one or more first hash values to the second hash values to determine which segments of the datasets differ.

3. The method of claim 1 further comprising the step of communicating the first and second hash values to a third host and wherein the step of comparing one or more first hash values to the second hash values to determine which segments of the datasets differ further comprises comparing, at the third host, one or more first hash values to the second hash values to determine which segments of the datasets differ.

4. The method of claim 1, further comprising the step of communicating from the first host to the second host one or more segments of the first dataset if the comparison determines that one or more segments of the first dataset differ from the second dataset.

5. The method of claim 4, wherein the step of communicating from the first host to the second host is conducted automatically once the comparison determines that one or more segments of the first dataset differ from the second dataset.

6. The method of claim 4, wherein the step of communicating from the first host to the second host is conducted only if the comparison determines that the total length of the differing segments is below a maximum threshold.

7. The method of claim 4, wherein the step of communicating from the first host to the second host one or more segments of the first dataset if the comparison determines that one or more segments of the first dataset differ from the second dataset further comprises choosing, from a plurality of communication medium options, a communication medium by which to transmit the differing segments based on the total length of the differing segments.

8. The method of claim 4, further comprising the step of compiling a third dataset that includes those segments of the first dataset determined to differ from the second dataset and those segments of the second dataset determined not to differ from the first dataset.

9. The method of claim 8, wherein the step of compiling a third dataset occurs at a host chosen from the group consisting of the first host, the second host or a third host.

10. The method of claim 4, further comprising the step of searching in the second dataset for a match to a subset of one of the first dataset segments communicated from the first host.

11. The method of claim 1 further comprising the step of isolating, iteratively, one or more differences within the one or more segments of the first and second datasets determined to have differed.

12. The method of claim 11 wherein the step of isolating, iteratively, one or more differences within the one or more segments of the first and second datasets determined to have differed further comprises the steps of:
creating third hash values, at the first host, corresponding to sub-segments of the segment of the first dataset determined to have differed;
creating fourth hash values, at the second host, corresponding to sub-segments of the segment of the second dataset determined to have differed; and
comparing the third hash values to the fourth hash values to determine which sub-segments of the segment differs.

13. The method of claim 12, further comprising the steps of communicating from the first host to the second host one or more sub-segments of the first dataset if a determination is made that one or more sub-segments of the segment differs.

14. The method of claim 13, further comprising the step of compiling a segment of the third dataset that includes those sub-segments of the first dataset determined to differ from the second dataset and those segments of the second dataset determined not to differ from the first dataset.

15. A method for expedited data transfer and data reconciliation in a communication network, the method comprising the steps of:
creating, at a first host, first hash values corresponding to segments of a first dataset;
communicating the first hash values to a second host having a second dataset residing thereon;
creating, at the second host, second hash values corresponding to segments of the second dataset;
comparing, at the second host, the first and second hash values to determine if a segment difference exists between corresponding first dataset segments and second dataset segments;
communicating to the second host one or more segments of the first dataset that have been determined to differ from the second dataset; and
compiling a third dataset that includes the one or more segments of the first dataset determined to differ from the second dataset and one or more segments of the second dataset determined not to differ from the first dataset.

16. The method of claim 15, further comprising the step of determining where, within the one or more segments determined to differ, the difference occurs.

17. The method of claim 15, further comprising the step of isolating a difference within a segment difference by iteratively comparing hash values corresponding to sub-segments of the segments determined to differ.

18. The method of claim 15, wherein the step of communicating to the second host those segments of the first dataset that have been determined to differ from the second dataset occurs automatically when a difference has been determined.

19. The method of claim 15, wherein the step of communicating to the second host one or more segments of the first dataset that have been determined to differ from the second dataset is conducted only if the comparison determines that the total length of the differing segments is below a maximum threshold.

20. The method of claim 15, further comprising the step of choosing, from a plurality of communication medium options, a communication medium by which to transmit the differing segments based on the total length of the differing segments.

21. The method of claim 15 further comprising the step of determining, if a segment difference exists, whether the differing segment exceeds a length threshold, thus, requiring further segmentation to isolate the difference.

22. The method of claim 21, further comprising the steps of:
creating if a segment difference has been determined to exceed the length threshold, third hash values corresponding to sub-segments of the second dataset segment in which the difference exists;
creating fourth hash values corresponding to sub-segments of the first dataset segment in which the difference exists; and
comparing the third and fourth hash lists to determine a sub-segment difference between corresponding first dataset sub-segments and second dataset sub-segments.

23. The method of claim 22, further comprising the step of determining, if a sub-segment difference exists, whether the differing sub-segment exceeds a length threshold.

24. The method of claim 23, further comprising the step of compiling a segment of the third dataset that includes one or more sub-segments of the first dataset that have been determined to differ from one or more sub-segments of the second dataset.

25. A method for determining differences between datasets residing on separate hosts in a communication network, the method comprising the steps:
creating first dataset hash values, at a first host, corresponding to segments of a first dataset; and
searching, at a second host, for segments of a second dataset that have matching hash values to the first dataset hash values using a slide function of a sliding hash algorithm.

26. The method of claim 25 wherein the step of searching, at second host, for segments of a second dataset that have matching hash values to the first dataset hash values using a slide function of a sliding hash algorithm, further comprises the steps of:
creating, at a second host, a first hash value for a first segment of a second dataset;
comparing the first hash value of the first segment of the second dataset to one or more of the first dataset hash values to determine if the first hash value matches any of the first dataset hash values;
sliding, by a predefined length, the first segment of the second dataset to create a second hash value for a second segment of the second dataset; and
comparing the second hash value to one or more first dataset hash values to determine if the second hash value matches any of the first dataset hash values.

27. The method of claim 26, further comprising the step of:
continuing to iteratively slide, by a predefined length, segments of the second dataset to create subsequent hash values for subsequent segments of the second dataset; and
comparing the subsequent hash values to the first dataset hash values to determine if the subsequent hash values match any of the first dataset hash values.

28. The method of claim 25 further comprising the step of communicating the first dataset hash values from the first host to the second host prior to searching, at the second host, for segments of a second dataset that have matching hash values to the first dataset hash values using a slide function of a sliding hash algorithm.

29. The method of claim 25, further comprising the step of communicating from the first host to the second host one or more segments of the first dataset if the comparison determines that one or more segments of the second dataset have no valid matches to segments of the first dataset.

30. The method of claim 29, wherein the step of communicating from the first host to the second host is conducted automatically once the comparison determines that one or more segments of the second dataset have no matching hash values amongst the first dataset first dataset hash values.

31. The method of claim 29, wherein the step of communicating from the first host to the second host is conducted only if the comparison determines that the total length of the differing segments is below a maximum threshold.

32. The method of claim 29, wherein the step of communicating from the first host to the second host one or more segments of the first dataset if the comparison determines that one or more segments of the first dataset differ from the second dataset further comprises choosing, from a plurality of communication medium options, a communication medium by which to transmit the differing segments based on the total length of the differing segments.

33. The method of claim 29, further comprising the step of compiling a third dataset that includes those segments of the second dataset that have matching hash values amongst the first dataset hash values and those segments of the first dataset determined not to have matching hash values amongst the hash values of the second dataset segments.

34. The method of claim 29, wherein the step of compiling a third dataset occurs at a host chosen from the group consisting of the first host, the second host or a third host.

35. A system for expedited data transfer and data reconciliation in a communication network, the system comprising:
a first processor residing in a first host, the first processor implements a hash algorithm to create first hash values corresponding to segments of a first dataset; and
a second processor residing in a second host and in network communication with the first processor, the second processor implements the first hash algorithm to create second hash values corresponding to segments of a second dataset;
wherein the first hash values are compared to the second hash values to determine which segments of the datasets differ and wherein the first host communicates to the second host one or more segments of the first dataset if a determination is made that one or more segments of the first dataset differ from the second dataset.

36. The system of claim 35, further comprising a compiler, in communication with the second processor, which compiles a third dataset that includes those segments of the first dataset determined to differ from the second dataset and those segments of the second dataset determined not to differ from the first dataset.

37. The system of claim 35, wherein the second processor is capable of searching in the second dataset for a match to a subset of one of the first dataset segments communicated from the first host.

38. The system of claim 35, wherein the first and second processors determine where, within the segments that have been determined to differ, the differences occur.

39. The system of claim 35, wherein the first and second processors isolate, iteratively, one or more differences within the one or more segments of the first and second datasets determined to have differed.

40. The system of claim 35, wherein the first processor implements the hash algorithm to create third hash values corresponding to sub-segments of the first dataset determined to have differed, the second processor implements the hash algorithm to create fourth hash values corresponding to sub-segments of the second dataset segments determined to have differed, wherein the first processor compares the third hash values to the fourth hash values to determine which sub-segments of the datasets differ.

41. The system of claim 35, wherein the second processor determines, if a segment difference exists, whether the differing segment exceeds a length threshold, thus, requiring further segmentation to isolate the difference.
